(19) United States
(12) Patent Application Publication
(10) Pub. No.: US 2020/0263737 A1
(43) Pub. Date: Aug. 20, 2020

(54) SLIP-BETWEEN-CENTER PROPELLER SHAFT ASSEMBLY WITH RADIAL THRUST RINGS

(71) Applicant: Neapco Intellectual Property Holdings, LLC, Farmington Hills, MI (US)

(72) Inventor: Robert Joseph Wehner, Livonia, MI (US)

(21) Appl. No.: 16/783,649

(22) Filed: Feb. 6, 2020

Related U.S. Application Data
(60) Provisional application No. 62/806,193, filed on Feb. 15, 2019.

(51) Int. Cl. F16D 3/06; F16C 3/035; F16D 1/10

(52) U.S. Cl. CPC F16D 3/06; F16D 2001/103; F16D 1/10; F16C 3/035

(57) ABSTRACT

A propeller shaft assembly including a first shaft that presents a plurality of external splines, and a second shaft that has an internal wall which defines an axial bore. The axial bore receives the first shaft and presents a plurality of internal splines that are interleaved with the external splines of the first shaft for providing relative axial movement between the first and second shafts while rotationally fixing the first and second shafts to one another. At least one thrust ring is positioned against the internal wall of the second shaft and surrounds the external splines of the first shaft. The at least one thrust ring has at least one contact portion that is radially deformed in a bending manner against the external splines for causing a radial preload against the external splines. The at least thrust ring extends between a pair of ends that are disposed in spaced relationship with one another to define a gap between the ends.

### CROSS-REFERENCE TO RELATED APPLICATIONS

This patent application claims the benefit and priority of U.S. Provisional Patent Application Ser. No. 62/806,193, filed Feb. 15, 2019, the entire disclosure of which is incorporated herein by reference.

### TECHNICAL FIELD

The subject disclosure relates to a propeller shaft assembly for a vehicle. More particularly, the subject disclosure relates to a slip-between-center propeller shaft assembly having at least one radial thrust ring for providing a radial preload force against external splines of a first shaft.

### BACKGROUND OF THE DISCLOSURE

It is known in the art for vehicle propeller shaft assemblies to have a first shaft and a second shaft connected with a “slip-between-center” which rotationally fixes, but allows axial movement between the first and second shafts in order to accommodate changes in length during vehicle operation. More particularly, the slip-between-center includes a plurality of external splines on the first shaft which are interleaved with a plurality of internal splines formed in a bore of the second shaft. A radial clearance between the interleaved splines is necessary to provide manufacturing tolerances and ease of assembly, but the same clearance prevents precise imbalance measurements and corrections due to small radial movements of the internal splines relative to the external splines.

In order to counter such radial movements of the internal splines relative to the external splines, it is known to provide a ring-shaped thrust ring at each end of the external splines for applying a radial force against an outer surface of the internal splines. The thrust rings are compressed radially during insertion of the second shaft into the bore of the first shaft which provides a tight interference fit about the internal splines. Although this interference fit eliminates radial movement between the internal and external splines, it also makes it difficult to manually insert the second shaft into the bore of the first shaft during assembly of the propeller shaft, and inhibits the ability of the first and second shafts to axially move relative to one another. Accordingly, the use of such thrust rights are not suitable for a slip-between-center propeller shaft assembly. As such, there remains a need for improvements to such vehicle propeller shaft assemblies.

### SUMMARY OF THE INVENTION

According to an aspect of the disclosure, a propeller shaft assembly includes a first shaft presenting a plurality of external splines, and a second shaft having an internal wall which defines an axial bore. The axial bore receives the first shaft and presents a plurality of internal splines that are interleaved with the external splines of the first shaft for providing relative axial movement between the first and second shafts while rotationally fixing the first and second shafts to one another. At least one thrust ring is positioned against the internal wall of the second shaft and surrounds the external splines of the first shaft. The at least one thrust ring has at least one contact portion that is radially deformed in a bending manner against at least one of the external splines for causing a radial preload against the external splines. The at one thrust ring extends between a pair of ends disposed in spaced relationship with one another to define a gap between the ends.

According to another aspect of the disclosure, a thrust ring for being positioned radially between external splines of a first shaft and an inner wall of a second shaft of a propeller shaft includes an elongated wall having at least one contact portion for being radially biased against at least one of the external splines of the first shaft for providing a radial pre-load against the external splines, and at least one spacing portion adjacent to the at least one contact portion. The elongated wall extends between a pair of ends disposed in spaced relationship with one another to define a gap between the ends.

Because the at least one thrust ring defines a gap between the ends, the thrust ring is able to be radially bent (not compressed) during insertion of the second shaft into the bore of the first shaft, thus making assembly of the propeller shaft easier. This shape of the thrust ring also allows the radial force applied against the internal splines to be selected such that it prevents radial movement and imbalances between the first and second shafts, while still allowing relative axial movement between the first and second shafts. Furthermore, the radial load achieved through bending of the at least one contact portion is lower and more precisely controlled in comparison to the thrust rings of the prior art that rely on a radial compression fit.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a side view of a propeller shaft assembly;

FIG. 2 is a side cross-sectional, partial view of a first and second shaft of the propeller shaft assembly;

FIG. 3 is a side view of a thrust ring of the propeller shaft assembly;

FIG. 4 is a perspective view of the thrust ring of the propeller shaft assembly;

FIG. 5 is a perspective cutaway view of the second shaft of the propeller shaft assembly illustrating the positions of two thrust rings adjacent to internal splines; and

FIG. 6 is a view along a central axis of the first and second shafts of the propeller shaft assembly illustrating an arrangement of three contact portions of a thrust ring of the second shaft engaging external splines of the first shaft.

### DESCRIPTION OF THE ENABLING EMBODIMENT

Referring to the Figures, wherein like numerals indicate correspond parts throughout the several views, a propeller shaft assembly 10 for a vehicle is provided. It should be appreciated that the subject propeller shaft assembly 10 may be employed for various types of vehicles including, but not limited to, automobiles and recreational vehicles.

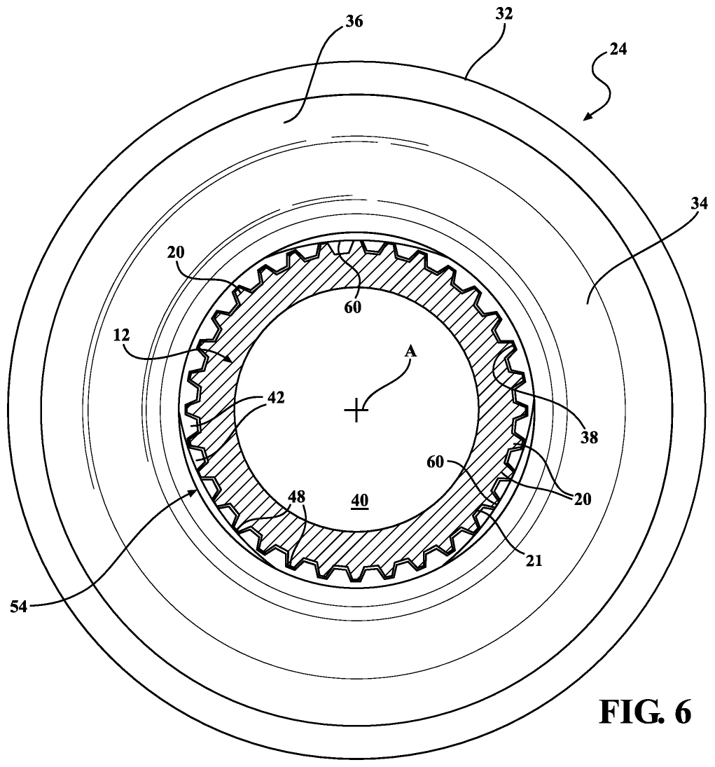

As best illustrated in FIGS. 2 and 6, the propeller shaft assembly 10 includes a first shaft 12 that extends along an axis A between a proximal end 14 and a distal end 16. A first universal joint 18 is connected to the proximal end 14. The first universal joint 18 is coupled, for example, to a first attachment yoke 70, which may be further connected to a transmission or transfer case of the vehicle for transmitting torque to the first shaft 12 from the transmission or transfer case. The first shaft 12 presents a plurality of external splines 20 adjacent to the distal end 16, each extending axially and in spaced circumferentially from one another by a plurality of recesses 21.

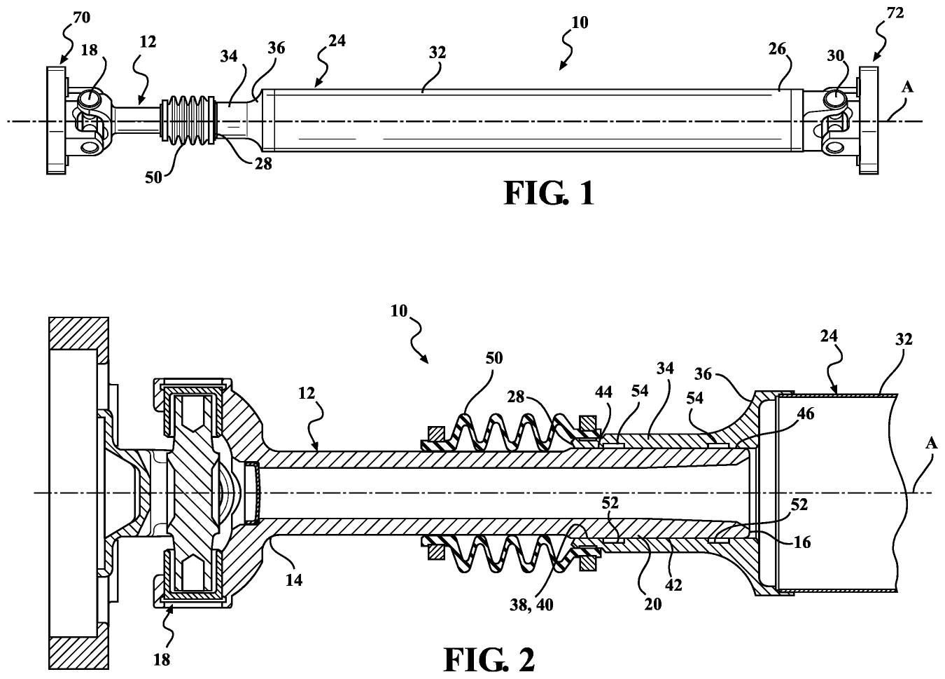

As best shown in FIG. 1, the propeller shaft assembly 10 further includes a second shaft 24 that extends axially between a base end 26 and a terminal end 28. A second universal joint 30 is connected to the base end 26. The second universal joint 30 is connected, for example, to a second attachment yoke 72, which may be further coupled to a differential of the vehicle for transmitting torque from the to the differential. The second shaft 24 has a tube portion 32 that extends axially from the base end 26, and a sleeve portion 34 that extends axially from the tube portion 32. The second shaft 24 further includes a tapered region 36 disposed between the tube portion 32 and the sleeve portion 34, and tapering radially inwardly from the tube portion 32 to the sleeve portion 34.

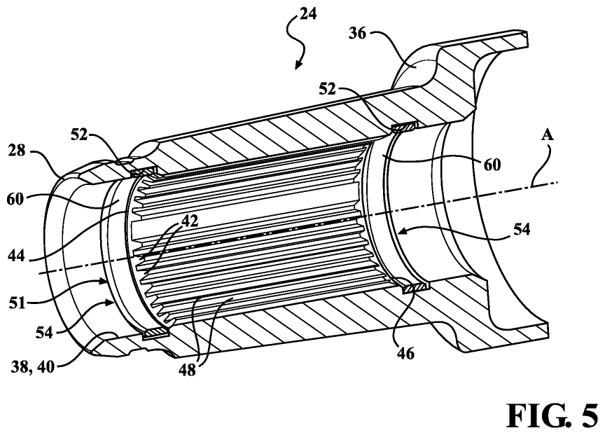

As best presented in FIGS. 2 and 5-6, the sleeve portion 34 includes an internal wall 38 which defines a bore 40 for receiving the distal end 16 of the first shaft 12. The internal wall 38 presents a plurality of internal splines 42 that extend axially between a first side 46 disposed adjacent to the distal end 16 of the first shaft 12, and a second side 44 spaced axially from the first side 46. The internal splines 42 are spaced circumferentially from one another by a plurality of channels 48 (best shown in FIGS. 5-6). As best illustrated in FIGS. 2 and 6, the internal splines 42 of the sleeve portion 34 and the external splines 20 of the first shaft 12 are interleaved with one another such that they allow relative axial movement between the first and second shafts 12, 24 while rotationally fixing the first and second shafts 12, 24 to one another.

A dust boot 50 partially surrounds the sleeve portion 34 of the second shaft 24 and the first shaft 12 for preventing debris from passing between the first and second shafts 12, 24 during axial movement between the first and second shafts 12, 24. The dust boot 50 is preferably comprised of an elastomeric material.

As best shown in FIG. 5, the internal wall 38 of the sleeve portion 34 defines at least one annular groove 52 that extends radially outwardly into the internal wall 38. According to a preferred arrangement, a pair of annular grooves 52 are positioned on opposite axial sides of the internal splines 42, each adjacent to one of the first and second sides 44, 46 of the internal splines 42. At least one thrust ring 54 is received in the at least one annular groove 52. According to the preferred arrangement, a pair of radial thrust rings 54 are each received in one of the annular grooves 52 and are disposed circumferentially about the external splines 20 of the first shaft 12. It should be appreciated that any number of annular grooves 52 and thrust rings 54 may be utilized.

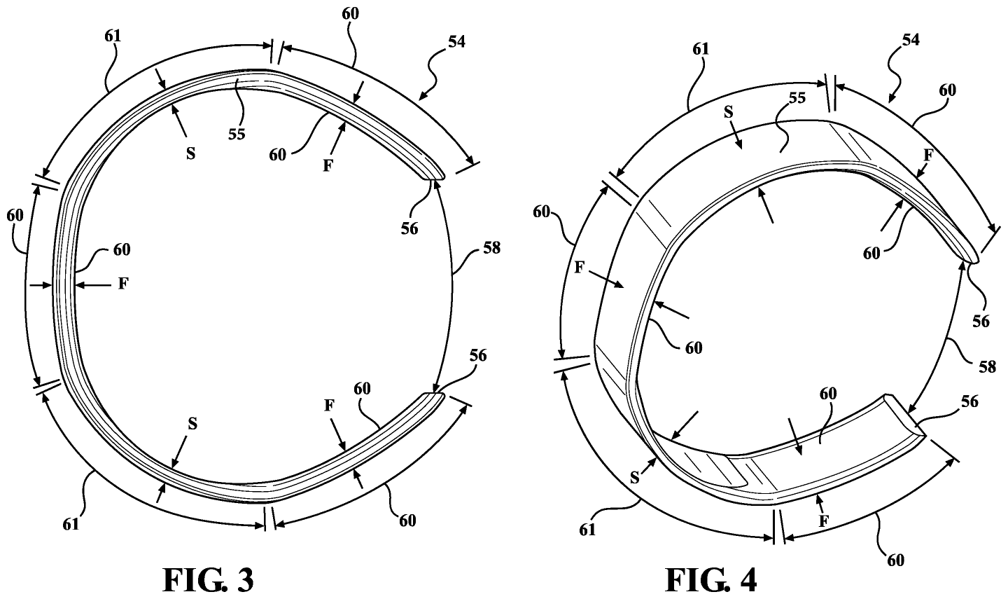

As best shown in FIGS. 3-4, each of the thrust rings 54 has an elongated wall 55 that generally has a C-shape and extends circumferentially between a pair of ends 56 disposed in spaced relationship with one another to define a gap 58 between the spaced ends 56. According to the example embodiment, the thrust rings 54 each have a variable radius across their length. Due to the C-shape of the thrust rings 54, they may easily be deformed into a desired shape for insertion into the bore 40 by bending. As best shown in FIGS. 3-4 and 6, the elongated wall 55 of each of the thrust rings 54 includes a plurality of contact portions 60 and a plurality of spacing portions 61 located alongside the contact portions 60. The contact portions 60 extend radially inwardly past the spacing portions 61. As such, an best shown in FIG. 6, the contact portions 60 extend radially past the channels 48 between the internal splines 42 such that they are radially deformed in a bending manner against the external splines 20 of the first shaft 12 to cause a consistent radial preload against the external splines 20 to mitigate the detrimental imbalance effects caused by radial clearance between the first and second shafts 12, 24. In the preferred arrangement, the thrust rings 54 engage a major diameter of the external spines 20, however the thrust rings 54 could engage other diametrical locations of the first shaft 12 without departing from the subject disclosure. The C-shape shape provided by the pair of ends 56 and gap 58 also allows the radial force applied against the external splines 20 to be chosen such that it prevents radial movement and imbalances between the first and second shafts 12, 24, while still allowing relative axial movement between the first and second shafts 12, 24. The plurality of contact portions 60 are preferably evenly circumferentially spaced from one another to evenly provide the radial preload against the external splines 20. In a preferred arrangement, the thrust rings 54 each include three contact portions 60, however other numbers of contact portions 60 could be employed without departing from the subject disclosure.

As further illustrated in FIGS. 3-4, the contact portions 60 of each of the thrust rings 54 have a first radial thickness F that is larger than a second radial thickness S of the spacing portions 61 of the thrust ring 54. In the preferred arrangement, the first thickness D is 1.75 mm and the second thickness S is 1 mm. The thicker first thickness F of the contact portions 60 is provided in order to provide adequate bending stiffness and radial preload against the external splines 20. Furthermore, the spacing portions 61 disposed between the contact portions 60 with the thinner second thickness S do not significantly add to the bending resistance of the thickened contact portions 60. This is provided because the gap 58 is provided between the contact portions 60 which allows contraction of the thrust ring 54 during assembly of the propeller shaft assembly 10, thus there is no additional bending resistance provided in the gap 58. By reducing the bending resistance in the spacing portions 61 between the contact portions 60, the effort required to contract the radial thrust ring 54 and close the gap 58 for insertion of the radial thrust ring 54 through the bore 40 during assembly into the sleeve portion 34 is reduced. A further benefit of reducing the bending resistance in the spacing regions 61 between the contact portions 60 is that a more uniform radial centering force at all three contact portions 60 is provided against the external splines 20 of the first shaft 12 after assembly of the first shaft 12 into the sleeve portion 34 of the second shaft 24.

The C-shape of the thrust rings 54 advantageously allows the thrust rings 54 to flex along the spacing portions 61 during assembly of the propeller shaft assembly 10. More particularly, during assembly, the thrust ring 54 deforms in this manner when the first shaft 12 is received in the bore 40 of the second shaft 24 and the external splines 20 are received between the internal splines 20. As a result, the radial thrust loads provided by the contact portions 60 of the thrust rings 54 is low and tightly controlled. This allows a frictional force that counters relative axial sliding movement between the first and second shafts 12, 24 to be tuned such that a desired amount of sliding movement between the first and second shafts 12, 24 during vehicle assembly and/or operation is provided while also inhibiting relative radial movement between the first and second shafts 12, 24. In a preferred arrangement, the thrust rings 54 are comprised of a glass-filled nylon or similar material to provide a low modulus (low bending stiffness), high strength and a low coefficient of friction. Polytetrafluoroethylene (PTFE), silicone or other additives may be used in the nylon material to further reduce friction. FIG. 6 illustrates the plurality of contact portions 60 prior to insertion of the first shaft 12. Insertion of the externally splined first shaft 12 radially deforms the contact portions 60 of the thrust rings 54 in a bending manner, causing the thrust rings 54 to conform to a more circular shape and provide a consistent radial preload between the internal and external splines 42, 20.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. A propeller shaft assembly, comprising:
a first shaft presenting a plurality of external splines;
a second shaft having an internal wall defining an axial bore for receiving said first shaft and presenting a plurality of internal splines interleaved with said external splines of said first shaft for providing relative axial movement between said first and second shafts while rotationally fixing said first and second shafts to one another;
at least one thrust ring positioned against said internal wall of said second shaft and surrounding said external splines of said first shaft, said at least one thrust ring having at least one contact portion radially deformed in a bending manner against at least one of said external splines for causing a radial preload against said external splines; and
said at least thrust ring extending between a pair of ends disposed in spaced relationship with one another to define a gap between said pair of ends.

2. The thrust ring as set forth in claim 1, wherein said thrust ring further includes at least one spacing portion adjacent to said at least one contact portion, and wherein said at least one contact portion extends radially inwardly to a further extent than said at least one spacing portion.

3. The propeller shaft assembly as set forth in claim 1, wherein said at least one thrust ring has a first radial thickness along said at least one contact portion, and wherein said at least one contact portion has a second radial thickness being less than said first radial thickness.

4. The propeller shaft assembly as set forth in claim 1, wherein said at least one contact portion of said thrust ring includes a plurality of contact portions being circumferentially spaced from one another by a respective one of said at least one spacing portions.

5. The propeller shaft assembly as set forth in claim 4, wherein said plurality of contact portions are evenly spaced from one another.

6. The propeller shaft assembly as set forth in claim 5, wherein said plurality of contact portions includes three contact portions and wherein said plurality of spacing portions includes two spacing portions.

7. The propeller shaft assembly as set forth in claim 1 wherein said at least one thrust ring is comprised of a glass-filled nylon material.

8. The propeller shaft assembly as set forth in claim 1 wherein said at least one thrust ring includes a pair of thrust rings being axially spaced from one another.

9. The propeller shaft assembly as set forth in claim 8 wherein said internal splines extend axially between a first side and a second side, and wherein one of said pair of thrust rings is disposed adjacent to said first side of said internal splines and the other of said pair of thrust rings is disposed adjacent to said second side of said internal splines.

10. The propeller shaft assembly as set forth in claim 9 wherein an annular groove is defined adjacent to each of said first and second sides of said internal splines, and wherein one of said pair of thrust rings is located in a respective groove of said annular grooves.

11. A thrust ring for being positioned radially between external splines of a first shaft and an internal wall of a second shaft of a propeller shaft, comprising:
an elongated wall having at least one contact portion for being radially biased against at least one of the external splines of the first shaft for providing a radial pre-load against the external splines, and at least one spacing portion adjacent to said at least one contact portion; and
said elongated wall extending between a pair of ends disposed in spaced relationship with one another to define a gap between said pair of ends.

12. The thrust ring as set forth in claim 11, wherein said at least one contact portion extends radially inwardly to a further extent than said at least one spacing portion.

13. The thrust ring as set forth in claim 11, wherein said elongated wall has a first radial thickness along said at least one contact portion that is greater than a second radial thickness along said at least one spacing portion.

14. The thrust ring as set forth in claim 11, wherein said at least one contact portion includes a plurality of contact portions being circumferentially spaced from one another by a respective one of said at least one spacing portion.

15. The thrust ring as set forth in claim 14, wherein said plurality of contact portions are evenly spaced from one another.

16. The thrust ring as set forth in claim 14, wherein said plurality of contact portions includes three contact portions, and wherein said at least one spacing portion includes two spacing portions.

17. The thrust ring as set forth in claim 11 wherein said elongated wall is comprised of a glass-filled nylon material.
